(19) United States
(12) Patent Application Publication
(10) Pub. No.: US 2023/0144587 A1
(43) Pub. Date: May 11, 2023

(54) DOOR ROTATING JACK

(71) Applicant: Jhacson Saavedra, Miami, FL (US)

(72) Inventor: Jhacson Saavedra, Miami, FL (US)

(21) Appl. No.: 17/669,069

(22) Filed: Feb. 10, 2022

Related U.S. Application Data
(60) Provisional application No. 63/277,356, filed on Nov. 9, 2021.

(51) Int. Cl. B66F 5/02; E04F 21/00

(52) U.S. Cl. CPC B66F 5/02; E04F 21/0023

(57) ABSTRACT

A pair of jacks for lifting doors to facilitate adding hardware to the doors, each jack comprising: a clamp for clamping one end of a door; a swivel connected to the clamp via a cylindrical member; a telescoping shaft attached to the rear end of the cylindrical member; a crank arm attached to the top of the telescopic shaft for selectively adjusting the height of the telescoping shaft; and a base including at least four wheels for moving the jack along the floor, wherein the bottom of the shaft is attached to the base.

### BACKGROUND

### Cross Reference to Related Applications

This patent application claims priority to provisional application 63147953 filed Feb. 10^{th} 2021, and titled “door rotating jack.” Provisional Patent Application 63147953 is hereby incorporated by reference in its entirety.

### Technical Field

The claimed embodiments generally relate to jacks for lifting heavy items, and more specifically relates to door jacks for facilitating the installation of hardware on doors.

### Description of the Related Art

The hanging of doors and installation of hardware to doors is a laborious, time consuming operation. This process typically requires more than one workman working on lifting the doors as well as installing the hardware. Even if one workman is doing the work, the process to be able to lift the door and flip the door in order to install the hardware on both sides, usually requires strength and physical endurance, which can really cut into the time and a workman’s efficiency. For instance, to install hardware on both sides of a door, a work man would have to be able to manually lift the door as well as manually flip the door, specify the proper place to install the hardware, as well as ensure that location of hardware on one side matches the location on the other side of the door. This in itself is a laborious process.

The above-described conventional method of lifting doors as well as installing door hardware has generally been a two-man operation, has been extremely time-consuming, and has been laborious involving stooping and back strain. To the best of the present applicant’s knowledge and belief, no hand tool has been available for facilitating the installation of hardware as such.

While there have been previous disclosures of and uses of door-hanging jacks, such prior devices have not proved to be as efficient or effective as desirable. Consequently, the disclosed improved door-hanging jack is effective to easily and simply allow a single workman to lift doors and install hardware both without undue effort and in a minimum of time.

### SUMMARY

Embodiments herein provide a means for improved door jacks for facilitating the installation of hardware to doors, for mechanical simplicity and reduced costs.

Accordingly, an improved design for a door jack is disclosed. The disclosed embodiments provide a simple yet effective means of installing door hardware. The disclosed embodiments provide a pair of jacks for lifting doors to facilitate adding hardware to the doors, each jack comprising: a clamp for clamping one end of a door; a swivel connected to the clamp via a cylindrical member; a telescoping shaft attached to the rear end of the cylindrical member; a crank arm attached to the top of the telescopic shaft for selectively adjusting the height of the telescoping shaft; and a base including at least four wheels for moving the jack along the floor, wherein the bottom of the shaft is attached to the base.

In alternative embodiments, the door jack further comprises a pair of wooden plates, wherein the clamp rests on top of one of the wooden plates, and a clamp that can be rotated in a clockwise or anti clockwise direction. In alternative embodiments, the door jack further comprises a clamp wherein the rotational movement of the clamp increases or decreases pressure on the wooden plate, on which the clamp rests, causing vertical movement of such a wooden plate. In alternative embodiments, the movement of the wooden plate results in a firm or weakened grip of an object, and the telescoping shaft, at its lower end, has multiple circular slots for the insertion of metal pegs. In additional embodiments, the position of insertion of the metal pegs into the circular slots is dependent upon the desired height requirement of the telescoping shaft, and the swivel can be rotated. Additionally, the rotation of the swivel causes the clamp and associated wooden plates to rotate, and the rotation of the clamp results in the object clamped to be rotated.

Reference in the specification to one embodiment or an embodiment means that a particular feature, structure or characteristic described in connection with the embodiment is included in at least one embodiment of the claimed device. The appearance of the phrase “in one embodiment” in various places in the specification do not necessarily refer to the same embodiment. Additional aspects of the claimed embodiments will be set forth in part in the description which follows, and in part will be obvious from the description, or may be learned by practice of the claimed embodiments. The aspects of the claimed embodiments will be realized and attained by means of the elements and combinations particularly pointed out in the appended claims. It is to be understood that both the foregoing general description and the following detailed description are exemplary and explanatory only and are not restrictive of the claimed embodiments.

### BRIEF DESCRIPTION OF THE DRAWINGS

Various exemplary claimed embodiments will be described in detail with reference to the following figures, wherein:

FIG. 1 is a side, perspective view of an embodiment of the door jack;

FIG. 2 is a front perspective view of an embodiment of the door jack;

FIG. 3 is a top aerial view of an embodiment of the door jack;

FIG. 4 is another top perspective side view of an embodiment of the door jack;

FIG. 5 is a rear perspective view of an embodiment of the door jack;

FIG. 6 is a further rear perspective view of an embodiment of the door jack;

FIG. 7 is a side perspective view of an embodiment of the door jack;

FIG. 8 is a side view of another embodiment of the door jack; and

FIG. 9 is a further side view of another embodiment of the door jack.

### DETAILED DESCRIPTION

The claimed embodiments are described more fully below with reference to the accompanying drawings, which form a part hereof, and which show exemplary embodiments for practicing the invention. However, embodiments may be implemented in many different forms and should not be construed as limited to the embodiments set forth herein; rather these embodiments are provided so that this disclosure will be thorough and complete, and will fully convey the scope of the invention to those skilled in the art. The following detailed description is, therefore, not to be taken in the limiting sense.

A benefit of the claimed embodiments is to overcome the deficiencies of the prior art by providing a door jack which can be adjusted easily by a single workman and to provide a door jack which is sturdy and stable enough to hold the door absolutely level and parallel to the floor while hanging such hardware, while jack apparatus can be easily adjusted.

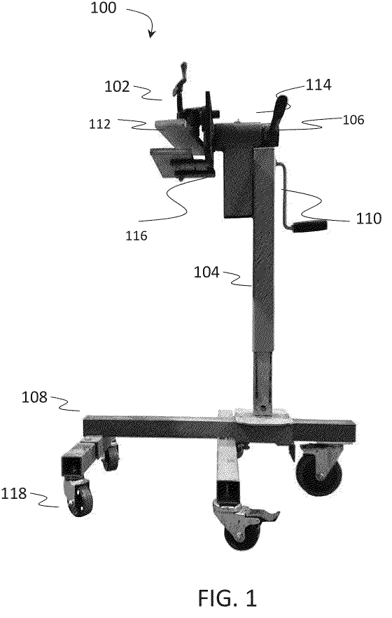

Referring now to the embodiment illustrated in FIG. 1, the figure illustrates generally a jack for lifting doors 100, having a clamp 102, attached to a wooden plate 112, the wooden plate further comprising top and bottom plates, the combination of the top and bottom wooden plates being utilized for gripping one end of a door. It is of note to mention that the other end of the wooden door is to be gripped by an identical jack, which will be adjusted according to the specifications as set for the first jack. Hence both the jacks work in uniformity, as a pair, to achieve the desired result.

The clamp 102 can be rotated in clockwise or anti clockwise manner so as to allow the wooden plate 112, upon which it sits, to be tightened or loosened. This allows for a firm grip with the desired object, typically a door requiring hardware installation. Further, such a rotational movement of the clamp 102 allows a strong grip of the door, ensuring there is no possibility of the door being held in a fragile manner. A cylindrical member 114 connects to the clamp 102 at the front end, via a vertical metal plate 116 , upon which the top and bottom wooden plates 112 rest. At the rear end of the cylindrical member 114 is attached a swivel 106, the rotational movement of the swivel allowing the clamp 102 and associated wooden plates 112 to be rotated. Such a movement of the clamp 102 and associated wooden plates also allows the corresponding door, that is gripped by the clamp 102, to be rotated.

The cylindrical member 114 further connects to a telescopic shaft 104 at the rear end. A crank arm 110 is attached to the top end of the telescoping shaft, such a crank arm 110 allowing the height of the telescoping shaft to be selectively adjusted. The bottom end of the telescopic shaft 104 is fitted into the base 108 of the jack. The base 108 comprises at least 4 wheels 118 allowing ease of movement of the jack along the floor.

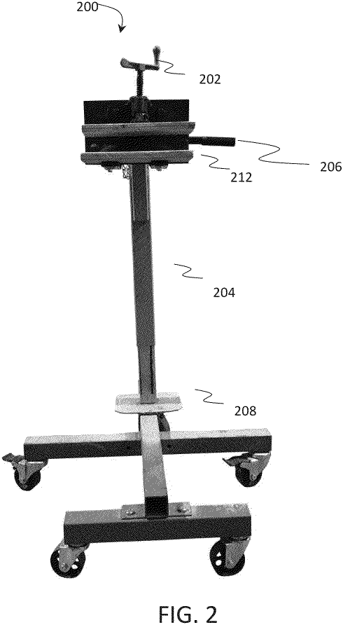

FIG. 2 depicts a front perspective view of an embodiment of the jack 200. As depicted in this embodiment, the clamp 202 is attached to one of the wooden plates 212, and a rotational movement of the clamp 202 increases or decreases pressure on the wooden plate, upon which the clamp 202 sits, allowing the strength of the grip of the wooden plates, on an object, to be increased or decreased. The swivel 206 is connected to the clamp via a cylindrical member (not depicted in this image), such swivel 206 allowing the clamp 202 and associated wooden plates to be rotated. This movement also allows rotation of the object being gripped by the clamp 202 and associated wooden plates. The telescopic shaft 204 is attached to the rear end of the cylindrical member (not depicted), and the bottom of such shaft 204 is inserted into the base 208. The base 208, in such an embodiment comprises at least 4 wheels, with 2 of the wheels horizontally connected to each other via a metal bar, and this pair sitting parallel to the remaining 2 wheels. Such an alignment of the wheels allows ease of movement of the jack along the floor.

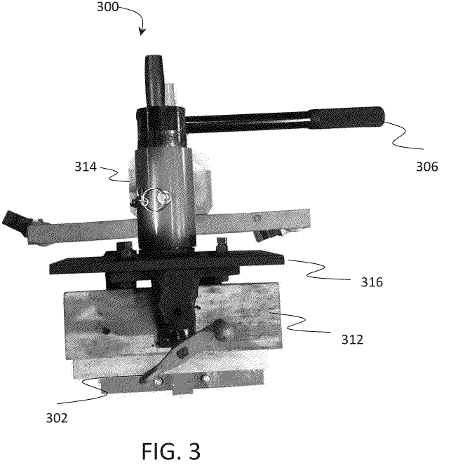

Turning now to FIG. 3, a top view of the embodiment of the jack 300 is depicted. In such an embodiment, the cylindrical member 314 is depicted to be attached to the metal plate 316. Such a metal plate 316 further having grasps upon which the top and bottom wooden pieces 312, associated with the clamp 302, are attached. Further, the swivel 306 is located at the rear end of the cylindrical member 314. As indicated previously, the movement of the swivel 306 allows the clamp 302 and associated wooden pieces 312 to be rotated in such a manner as desired. It is to be noted that each jack works as a pair with another jack. Once the desired height and grip is achieved with one jack, an operator turns his attention to the other jack and makes adjustments to achieve the same desired height and tightness of grip, so as to allow ease of movement of the gripped object.

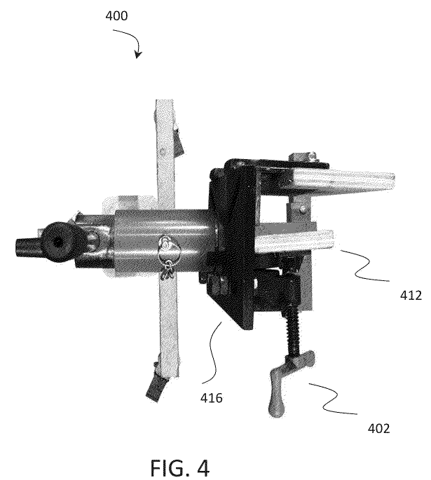

FIG. 4 depicts another top perspective view of the jack 400. In this instance, the metal plate 416 is depicted to show the attachment of the top and bottom wooden pieces 412. Further, the clamp 402, by its rotational movement, exerts pressure on the wooden piece 412 it rests on, allowing such a piece to make a tight grip with the object to be clasped. The wooden piece adjacent to the piece on which the clamp 402 rests on, stays in place and does not participate in any movement. This movement ensures that a tight grip is achieved as well as maintained with the object clasped.

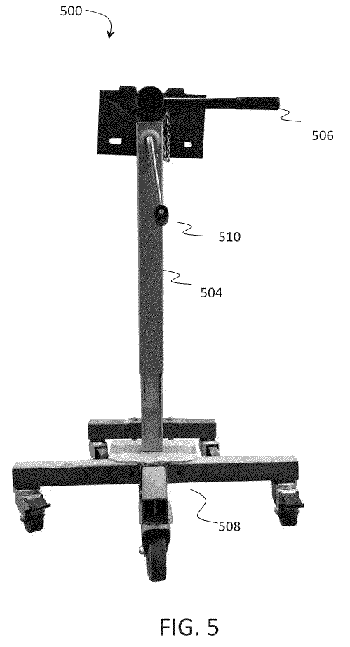

FIG. 5 depicts a rear perspective view of an embodiment of the jack 500. In this instance, the swivel 506 is depicted to be in one position. The telescopic shaft 504 is seen attached to the crank arm 510 at the top end of the shaft. A rotational movement of the crank arm 510 allows the telescopic shaft 504 to be increased or decreased in height, in order to assist in reaching a particular level of vertical height, to grasp the desired object. The telescopic shaft 504 is further depicted to be coupled to the base 508 of the jack 500 via a base plate. Also, as shown, the base wheels allow for ease of movement of the jack along the floor.

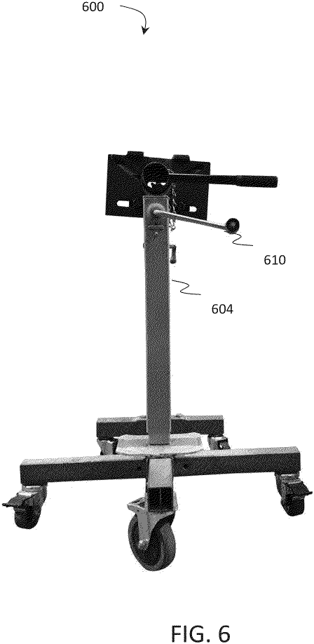

FIG. 6 depicts another rear perspective view of the jack 600. In such an embodiment, the crank arm 610 has been rotated in such a manner so as to allow the height of the telescopic shaft 604 to be decreased. It is also to be noted that the corresponding height of the other pair of jacks is also accordingly adjusted so that both the pairs of jacks are at the same height, as is the object to be grasped.

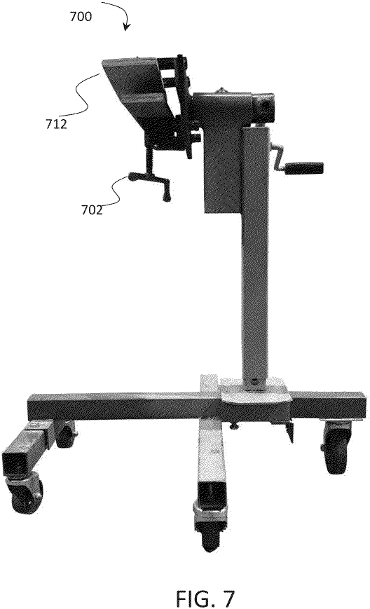

FIG. 7 depicts a side perspective view of the jack 700. In this embodiment, the position of the swivel is altered from its previous resting position, allowing the rotational movement of the clamp 702 and associated wooden plates 712. In such an instance, the movement of the clamp 702 and associated wooden plates 712 also allows the object that is being gripped to be rotated as well.

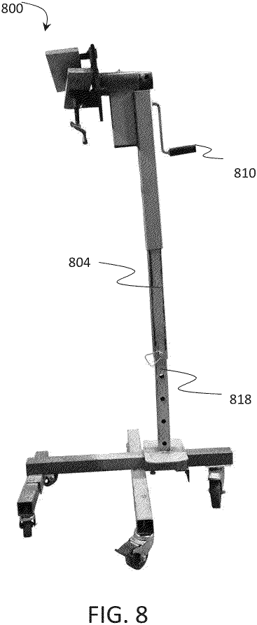

FIG. 8 depicts a side perspective view of another embodiment of the jack 800. In such a depiction, the position of the swivel has been altered as mentioned before. Further, the crank arm 810 has also been rotated in such a manner so as to increase the height of the telescopic shaft 804. In order to further aid in such an increase of the height of the telescoping shaft 804 the telescopic shaft has circular holes 818 at the bottom of such shaft, into which metal pegs can be inserted. In such an instance the telescopic shaft 804 can be pulled up and down and the position of insertion of the metal pegs is dependent upon the desired height requirement of the telescoping shaft 804. In other words, the insertion of the metal pegs into the telescoping shaft allows for further height adjustment as well as stability for the telescopic shaft.

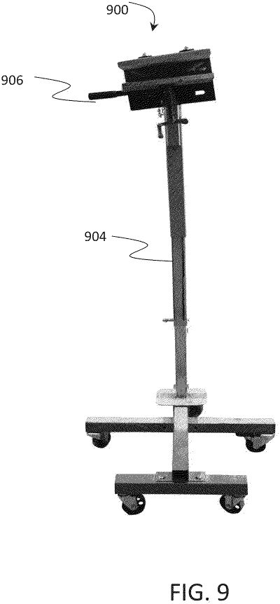

FIG. 9 depicts another side perspective view of an embodiment of the jack 900. In such a depiction of the invention, the swivel 906 is adjusted so as to allow the rotational movement of the clamp as well as associated wooden plates. This also allows for rotation of the object being gripped by the clamp and wooden plates. This further allows for ease of installation of any hardware on a door, for example, without having an operator putting in too much physical effort or having to have another person assist him. For example, if it is desired that some hardware needs to be installed at the back side of the door, instead of having to manually move the whole door, the operator mainly needs to twist the swivel 906 allowing for the rotation of the door, and ease of reach of such bottom end of the door. Further, this embodiment also depicts the telescopic shaft’s height being adjusted so as to allow ease of gripping the desired object.

It will be understood from a reading of the detailed description of the preferred embodiments, the benefits of the claimed embodiments and the appended claims that further modifications of the claimed embodiments may be made consistent with the scope of the subject matter as taught herein which is to be broadly construed in view of the claims appended hereto. Further, while particular details of construction of various components of the apparatus are disclosed herein, various alternative arrangements may be employed. Other modifications and changes in construction of the various components of the claimed embodiments may also be modified within the spirit and scope of the claimed embodiments.

1. A pair of jacks for lifting doors to facilitate adding hardware to the doors, each jack comprising:
a. a clamp for clamping one end of a door;
b. a swivel connected to the clamp via a cylindrical member;
c. a telescoping shaft attached to the rear end of the cylindrical member;
d. a crank arm attached to the top of the telescopic shaft for selectively adjusting the height of the telescoping shaft; and
e. a base including at least four wheels for moving the jack along the floor, wherein the bottom of the shaft is attached to the base.

2. The jack of claim 1, further comprising a pair of wooden plates, wherein the clamp rests on top of one of the wooden plates.

3. The jack of claim 1, wherein the clamp can be rotated in a clockwise or anti clockwise direction.

4. The jack of claim 3, wherein the rotational movement of the clamp increases or decreases pressure on the wooden plate, on which the clamp rests, causing vertical movement of such wooden plate.

5. The jack of claim 4, wherein the movement of the wooden plate results in a firm or weakened grip of an object.

6. The jack of claim 1 wherein the lower end of the telescoping shaft has multiple circular slots for the insertion of metal pegs.

7. The jack of claim 6, wherein the position of insertion of the metal pegs into the circular slots is dependent upon the desired height of the telescoping shaft.

8. The jack of claim 1, wherein the swivel can be rotated.

9. The jack of claim 8, wherein the rotation of the swivel causes the clamp and associated wooden plates to rotate.

10. The jack of claim 9, wherein the rotation of the clamp results in the object clamped to be rotated.
